(19) United States
(12) Patent Application Publication
(10) Pub. No.: US 2015/0149923 A1
(43) Pub. Date: May 28, 2015

(54) IMAGE PROCESSING APPARATUS, METHOD OF CONTROLLING THE SAME, AND STORAGE MEDIUM

(71) Applicant: CANON KABUSHIKI KAISHA, Tokyo (JP)

(72) Inventor: Yohei Shogaki, Kawasaki-shi (JP)

(21) Appl. No.: 14/541,895

(22) Filed: Nov. 14, 2014

(30) Foreign Application Priority Data
Nov. 26, 2013 (JP) 2013-244333

(51) Int. Cl. G06F 3/0484; G06T 1/60

(52) U.S. Cl. CPC G06F 3/04847; G06T 1/60
USPC 715/747

(57) ABSTRACT

An image processing apparatus stores, in a memory, a personal setting value and a sharing setting value which are set for the image processing apparatus, and controls, when a user, having an authority for modifying both the personal setting value and the sharing setting value, modifies, via an operation unit for accepting an operation of the user, the personal setting value of the user or the sharing setting value stored in the memory, to display the modified personal setting value or the modified sharing setting value on a display unit.

### BACKGROUND OF THE INVENTION

1. Field of the Invention

The present invention relates to an image processing apparatus, a method of controlling the same, and a storage medium.

2. Description of the Related Art

Conventionally, regarding settings pertaining to functions of an image processing apparatus such as a multi function peripheral, the image processing apparatus has only one set of setting values, and a plurality of users use the functions of the image forming apparatus sharing those setting values. In this kind of usage pattern, in a case where one user modifies one of the setting values, often the setting value is modified to be something that another user does not want, and so convenience is reduced.

In order to solve this problem, an image forming apparatus that is provided with respectively different personal setting values for each user is being considered. However, even if the personal setting values exist for each user, there are cases in which users wish to use sharing setting values, and so there is demand for having an arrangement in which it is possible to switch between individual personal setting values and sharing setting values.

In Japanese Patent Laid-Open No. 2009-111578, a technique is disclosed in which, in a case where sharing setting values and personal setting values for each user exist, setting value switch information pertaining to whether the sharing setting values or the personal setting values should be enabled is stored for each user, and based on the switch information the appropriate setting values are enabled.

With the technique disclosed in Japanese Patent Laid-Open No. 2009-111578, there is a problem in that in a case where a state is such that the personal setting values are used preferentially, even if the sharing setting value are modified, a user cannot confirm the modified sharing setting values.

### SUMMARY OF THE INVENTION

An aspect of the present invention is to eliminate the above-mentioned problems with conventional technology.

A feature of the present invention is to provide a technique even in a state in which a personal setting value of a user is used preferentially, it is possible, for the user, to confirm modified contents of a sharing setting value.

The present invention in its first aspect provides an image processing apparatus, comprising: an operation unit configured to accept an operation of a user; a storage unit configured to store a personal setting value and a sharing setting value which are set for the image processing apparatus; and a display control unit configured to control, when a user, having an authority for modifying both the personal setting value and the sharing setting value, modifies the personal setting value of the user or the sharing setting value stored in the storage unit via the operation unit, to display modified personal setting value or modified sharing setting value on a display unit.

The present invention in its second aspect provides an image processing apparatus, comprising: an operation unit configured to accept an operation of a user; a storage unit configured to store a personal setting value and a sharing setting value which are set for the image processing apparatus; a determination unit configured to determine, when the operation of the user is accepted via the operation unit, whether or not the user has an authority for executing processing giving priority to the personal setting value of the user; and a control unit configured to control:

(i) when the determination unit determines that the user has the authority, to execute processing using the personal setting value of the user, and,

(ii) when the determination unit determines that the user does not have the authority, to execute processing using the sharing setting value stored in the storage unit.

The present invention in its third aspect provides an image processing apparatus, comprising: an operation unit configured to accept an operation of a user; a storage unit configured to store a personal setting value and a sharing setting value which are set for the image processing apparatus; a determination unit configured to determine, when the operation of the user is accepted via the operation unit, whether or not a setting value to be used is the personal setting value or the sharing setting value; and a control unit configured to control to execute processing using the personal setting value or the sharing setting value determined by the determination unit to be used.

The present invention in its fourth aspect provides a method of controlling an image processing apparatus, the method comprising: accepting an operation of a user; storing, in a memory, a personal setting value and a sharing setting value which are set for the image processing apparatus; and controlling, when a user, having an authority for modifying both the personal setting value and the sharing setting value, modifies, in the accepting, the personal setting value of the user or the sharing setting value stored in the memory, to display modified personal setting value or modified sharing setting value on a display unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for explaining an example of a hardware configuration of an image processing apparatus (MFP) according to a first embodiment.

FIG. 2 depicts a view illustrating an example of a selection screen which is for selecting personal setting values or sharing setting values, and which is displayed on a display unit of the MFP according to the first embodiment.

FIG. 3 depicts a view illustrating an example of a setting value modification screen which is for modifying setting values and which is displayed on the display unit of the MFP according to the first embodiment.

FIG. 4 is a flowchart for describing processing of the MFP when a user performs a setting value modification operation on the MFP according to the first embodiment.

FIG. 5 is a flowchart for describing processing that the MFP according to the first embodiment executes, based on a personal or sharing setting value, in response to a user operation.

FIG. 6 is a flowchart for describing an example of execution of processing in accordance with a personal setting of the MFP according to the first embodiment, in a case where a user modifies the personal setting.

FIG. 7 is a flowchart for describing processing for accepting a modification of a setting value by a user in the MFP according to a second embodiment.

FIG. 8 is a flowchart for describing an example for executing processing in accordance with a setting value of a personal setting or a sharing setting, in a case where a user modifies the setting value of a personal setting or a sharing setting of the MFP according to the second embodiment.

FIG. 9 is a flowchart for showing processing for obtaining a setting value based on setting obtainment destination information.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

### First Embodiment

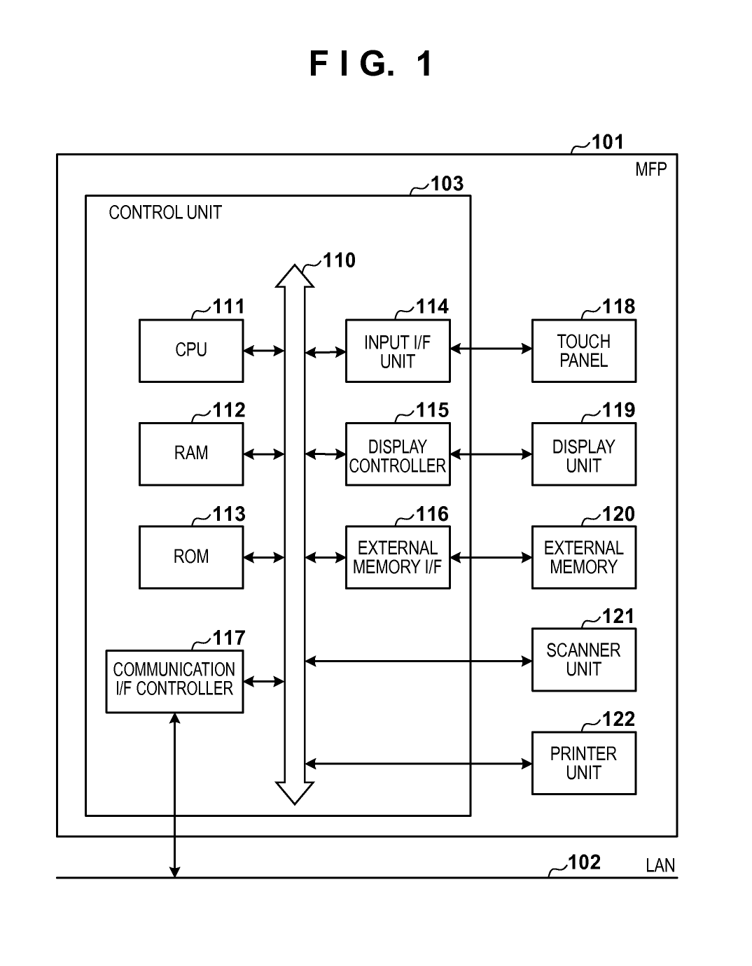

FIG. 1 is a block diagram for explaining an example of a hardware configuration of an image processing apparatus according to a first embodiment. Here, explanation will be given with the example of a multi function peripheral (MFP) functioning as the image processing apparatus.

An MFP 101 comprises a control unit 103, a touch panel 118, a display unit 119, an external memory 120, a scanner unit 121, and a printer unit 122. The control unit 103 comprises a CPU 111, a RAM 112, a ROM 113, an input I/F unit 114, a display controller 115, an external memory I/F 116, and a communication I/F controller 117, and they are connected via a system bus 110. The touch panel 118 is connected to the control unit 103 through the input I/F unit 114. The display unit 119 and the external memory 120 are connected to the control unit 103 through the display controller 115 and the external memory I/F 116 respectively.

The ROM 113 is a non-volatile memory, and image data, other data, various programs for operation of the CPU 111, or the like, are each stored in a predetermined region of the ROM 113. The RAM 112 is a volatile memory, and is used as a temporary storage area for a main memory of the CPU 111, a work area, or the like. The CPU 111 controls each unit of the MFP 101 using the RAM 112 as a work memory, in accordance with, for example, a program stored in the ROM 113. Note that programs for operation of the CPU 111 may be stored in the external memory 120 (a hard disk drive, or the like) in advance, and are not limited to being stored in the ROM 113.

The input I/F unit 114 generates a control signal in accordance with a user operation accepted by the touch panel 118, and supplies the control signal to the CPU 111. For example, the input I/F unit 114 accepts a signal in accordance with the user operation from a keyboard (not shown), a mouse (not shown), or the touch panel 118 functioning as an input device. Note that the touch panel 118 is an input device that outputs coordinate information in accordance with a location of a contact to, for example, an input unit configured in a flat surface. The CPU 111 controls each unit of the MFP 101 in accordance with programs, based on the control signals generated and supplied by the input I/F unit 114 in accordance with user operations performed on the input device. With this, the MFP 101 is able to perform an operation in accordance with a user operation.

The display controller 115 outputs a display signal for causing an image to be displayed on the display unit 119. For example the CPU 111 supplies a display control signal generated in accordance with a program to the display controller 115. The display controller 115 generates a display signal based upon the display control signal, outputs image data to the display unit 119, and causes an image to be displayed. For example, the display controller 115 causes a GUI screen comprised in a GUI (Graphical User Interface) to be displayed on the display unit 119 based on the display control signal generated by the CPU 111.

Note that the touch panel 118 is configured with the display unit 119 integrally, and functions as an operation unit. Furthermore, the operation unit may be provided with various hard keys, or the like. For example, the touch panel 118 is configured so that the light transmittance of the touch panel 118 does not to obstruct the display of the display unit 119, and is attached on an upper layer of display surface of the display unit 119. Input coordinates on the touch panel 118 are associated with display coordinates of a screen of the display unit 119. With this, a GUI, with which a user can operate the screen displayed on the display unit 119 directly, is configured. Any of a variety of touch panel types, such as a resistive type, a capacitance type, a surface acoustic wave type, an infrared type, an electromagnetic induction type, an image recognition type, or an optical sensor type, may also be employed for the type the touch panel 118.

The external memory 120 (for example, a hard disk drive, a CD, a DVD, a memory card, or the like) is mountable to the external memory I/F 116. The external memory I/F 116 reads out data from the external memory 120 and writes data in the external memory 120, in accordance with the control of the CPU 111. The communication I/F controller 117 performs communication over the network 102 (may be any of various kinds of networks such as, for example, a LAN, the Internet, a wired connection, a wireless connection, or the like) in accordance with control of the CPU 111. A variety of apparatuses, such as a PC, another MFP, a printer, a server, or the like, are connected to the network 102 and able to communicate with the MFP 101.

The scanner unit 121 scans an original, and generates image data of the original image. The printer unit 122 executes print processing based on a user instruction inputted via the input I/F unit 114 or print data inputted by an external apparatus via the communication I/F controller 117.

It is possible for the MFP 101 to save image data obtained by the scanner unit 121 or image data received by the communication I/F controller 117 in the RAM 112 or the external memory 120. Also, the MFP 101 saves image data received from a portable storage medium, (a USB memory, a memory card, or the like) which is mounted to the external memory I/F 116, into the RAM 112 or the external memory 120. Note that saved image data may be data to which various settings, including a setting value for printing for image data of an original which is read in by the scanner unit 121, are reflected. Also, the image data displayed on the display unit 119 may include character information, may include image information such as for a photograph or a graphic image, and may include both of these, or other kinds of information. Also, image data may be for a sample image saved internally beforehand.

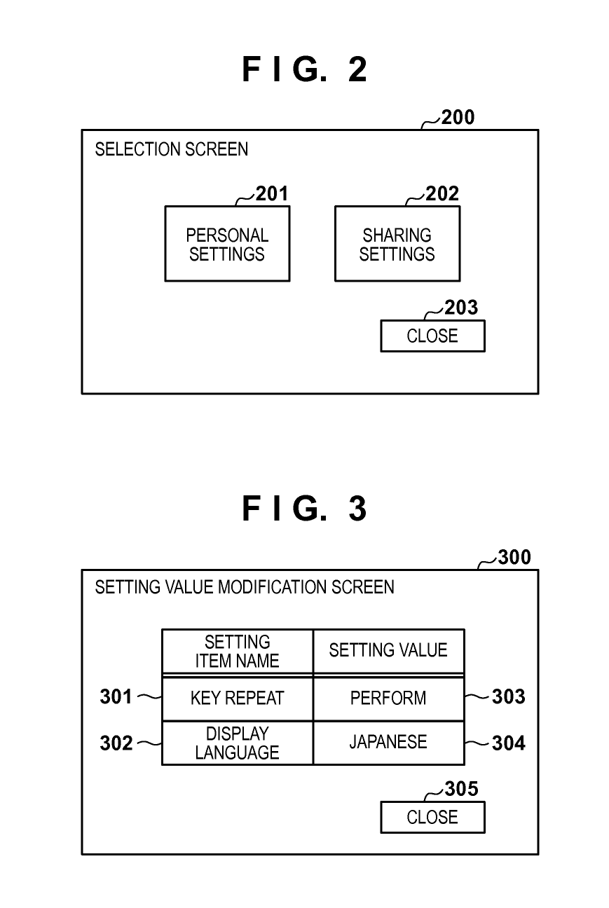

FIG. 2 depicts a view illustrating an example of a selection screen which is for selecting personal setting values or sharing setting values and which is displayed on the display unit 119 of the MFP 101 according to the first embodiment.

A selection screen 200 is a screen for accepting a selection of whether to modify personal setting values or sharing settings; the selection screen 200 includes a personal settings button 201, a sharing settings button 202, and a close button 203. The personal settings are setting values provided for each individual person (user), and sharing settings are setting values shared by a plurality of users.

A concrete example is explained as follows. For example, one setting item is for a display language. Each language, such as Japanese, English, German, or the like, exists as an alternative for a display language setting value. In such a case, the personal setting value of one user may be Japanese, while the personal setting value of another user may be German. Also, it is possible to set English as the sharing setting value which may be shared by a plurality of users. In such a case, if the user having the personal setting value of Japanese uses the personal setting, the display language is Japanese. On the other hand, if the user uses the sharing setting, the display language is English. In this way, separately from the sharing settings which are shared by a plurality of users, the setting values for each individual user are referred to as personal settings.

Note that the personal setting items may be a part of the setting items existing as sharing settings, or may be all of the sharing settings, and setting items that are only for personal settings may also exist.

The personal settings button 201 is a button for making an instruction to modify the personal setting values. By pressing the personal settings button 201, the personal setting values provided for an individual user can be altered. The sharing settings button 202 is a button for making an instruction to modify the sharing setting values. By pressing the sharing settings button 202, the sharing setting values can be altered. The close button 203 is a button for confirming a setting selected in the selection screen 200. When the close button 203 is pressed, the CPU 111 closes the selection screen 200, causes a transition to another screen, and stores the setting values selected by a user in the memory such as the RAM 112 or the external memory 120.

FIG. 3 depicts a view for illustrating an example of a setting value modification screen which is for modifying the setting value and which is displayed on the display unit 119 of the MFP 101 according to the first embodiment. The setting value modification screen 300 is a screen for accepting modify instructions from a user for setting values.

The setting value modification screen 300 comprises setting item names 301 and 302, setting value display areas 303 and 304, and a close button 305.

The setting item names 301 and 302 are associated with the setting values in one-to-one relationships, and the setting value corresponding to each setting item is displayed in the display areas 303 and 304 respectively. The display areas 303 and 304 call up the setting value corresponding to the setting item from a memory such as the ROM 113, the RAM 112, or the external memory 120, and display the setting value.

By selecting the setting item names 301 and 302 or the setting value display areas 303 and 304, a screen (not shown) for allowing selection of modification candidates for the setting value corresponding to the setting item is displayed, and a new setting value can be set using the screen. Note that a screen specification, in which rather than displaying the screen for allowing selection of a modification candidate for the setting value, a different setting value is displayed in the display area 303 every time the setting item name 301 or the setting value display area 303 is selected and the setting value is set, may be employed.

For example in a case where a user wants to modify the display language, the user touches “display language”, which is the display name 302 in FIG. 3. With this, a list of selectable languages for the display language is displayed in a pull-down menu, for example, or the like. Then when a desired language is touched by the user, the language is set to the display language. The selected language is displayed on the display area 304, which corresponds to “display language”, which is the display name 302. Note that “key repeat” and “display language” are shown as the setting items in FIG. 3, but of course there may be many other setting items.

The close button 305 is a button for confirming a modified setting value in the setting value modification screen 300. When the close button 305 is pressed, the CPU 111 closes the setting value modification screen 300, causes a transition to another screen, and stores the modified setting value in a memory such as the RAM 112 or the external memory 120. Note, a cancel button, which is omitted in FIG. 2 and FIG. 3, for cancelling a setting made of the screen may be arranged.

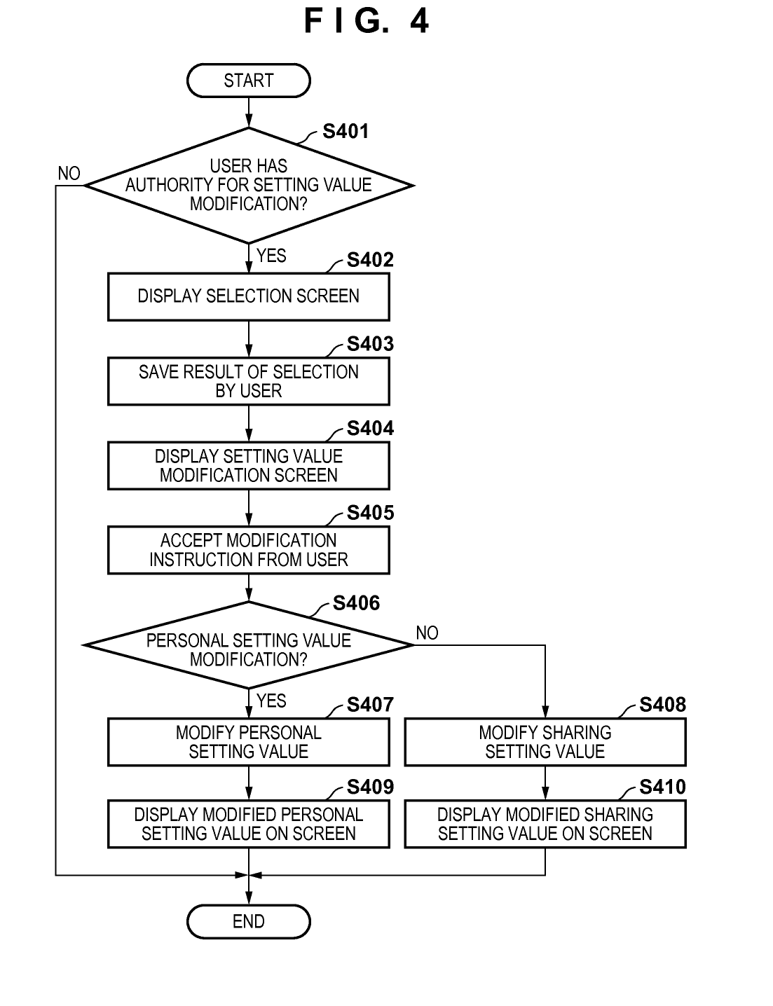

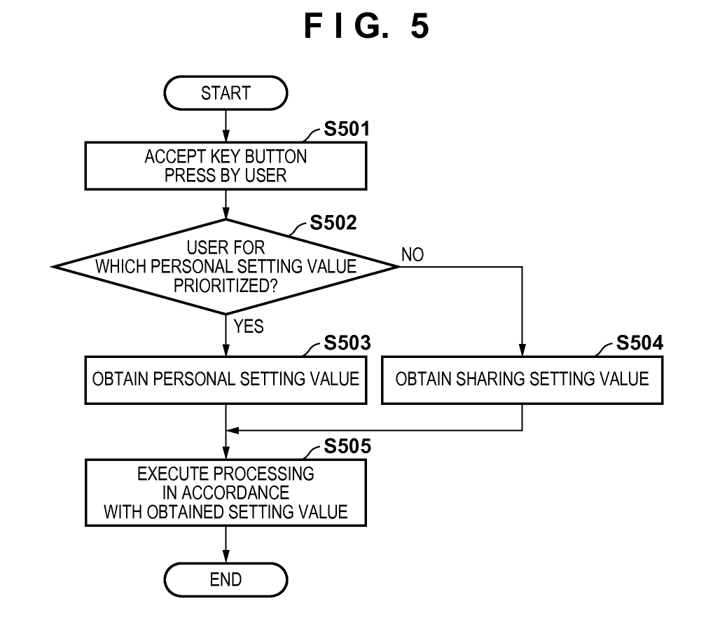

Next, explanation will be given in detail for a processing sequence for modification of a setting value by a selection of a user and modification of the display of the screen displayed on the display unit 119, using a flowchart in FIG. 4.

FIG. 4 is a flowchart for describing processing of the MFP 101 when a user performs a modification operation on a setting value on the MFP 101 according to the first embodiment. Note that this processing is realized by the CPU 111 of the MFP 101 deploying into the RAM 112, and executing, a program stored in the ROM 113 or the external memory 120.

First, the CPU 111 determines whether a user has an authority to modify setting values for both sharing setting values and personal setting values in step S401. At this time, the CPU 111 performs a user authentication, and obtains authority information of the user. The obtained authority information of the user includes information about whether or not the user has an authority to modify both sharing setting values and personal setting values. Also, information about whether or not the user has an authority to modify only the personal setting values and information about whether or not the user has an authority to modify only the sharing setting values may be included. The CPU 111 determines an existence or absence of the authority of the user by referencing the authority information of the user. Here, if the CPU 111 determines that the user has the authority to modify both the personal and sharing setting values, the CPU 111 advances the processing to step S402. On the other hand, if the CPU 111 determines that the user doesn't have the authority to modify both the personal and sharing setting values, the setting value modification processing that is performed may be limited to either the sharing setting values or the personal setting values, but explanation of such processing is omitted; here, if the CPU 111 determines that the user does not have the authority, the process is terminated.

In step S402, the CPU 111 displays the selection screen 200, explained with reference to FIG. 2, on the display unit 119, and the processing proceeds to step S403. When the selection screen 200 is displayed in step S402, the CPU 111 accepts a selection of the personal settings button 201 or the sharing settings button 202 by the user. Then, in step S403, the CPU 111 stores, in the RAM 112, a result of the selection of either the personal setting values or the sharing setting values, which is accepted from the user, and advances the processing to step S404. In step S404, the CPU 111 displays, on the display unit 119, the setting value modification screen 300 explained with reference to FIG. 3, and the processing proceeds to step S405. In step S405, the CPU 111 accepts a modification instruction for the setting value corresponding to the setting item, in response to an operation of the user on the setting value modification screen 300, and advances the processing to step S406.

In step S406, the CPU 111 reads out the selection result stored in step S403, and determines whether the selection is for the personal settings or the sharing settings. If the CPU 111 determines that the selection is for the personal settings in step S406, the processing proceeds to step S407, and if the CPU 111 determines to be the selection is for the sharing settings, the processing proceeds to step S408. In step S407, the CPU 111 modifies the personal setting value to be the setting value that the user instructed by overwriting the memory area of the external memory 120, or the like, in which the modified personal setting value is stored, with the setting value for which the modification instruction is accepted, and then the processing proceeds to step S409. In step S409, the CPU 111 displays the modified personal setting value in one of the setting value display areas 303 and 304 of the setting value modification screen 300, and the processing ends.

Meanwhile, in step S408, the CPU 111 modifies the sharing setting value that the user instructed by overwriting the memory area of the external memory 120, or the like, in which the modified sharing setting value is stored, with the setting value for which the modification instruction is accepted, and then the processing proceeds to step S410. In step S410, the CPU 111 displays the modified sharing setting value in one of the setting value display areas 303 and 304 of the setting value modification screen 300, and the processing ends.

Note that the CPU 111 may perform various processing until the modification is reflected in the display on the display unit 119 after the setting value has been modified. For example, if a function for monitoring modification of setting values is provided, and a setting value is modified, notification is made, as an event, that the setting value is updated. Furthermore, if the CPU 111 is provided with a function for receiving a notification of an event, and a notification of an event is received, key information identifying the updated setting item is received together with the notification of the event. The CPU 111 reads out of memory a setting value corresponding to the key information based on the key information. Then, the CPU 111 displays the read out setting value on the display unit 119. Such a configuration may also be taken.

In this way, a user, having an authority to modify both sharing setting values and personal setting values, is able to update the personal setting value of the user and the sharing setting value by modifying these settings.

Next, explanation will be given for processing of the MFP 101 that is performed based on a personal or sharing setting value.

FIG. 5 is a flowchart for describing processing that the MFP 101 according to the first embodiment executes, based on a personal or sharing setting value, in response to a user operation. Note that this processing is realized by the CPU 111 of the MFP 101 deploying into the RAM 112, and executing, a program stored in the ROM 113 or the external memory 120. Note that explanation will be given for an example in which the setting item is “key repeat”, but the present invention is not limited to this, and other setting items may be applied as well. Here, the setting of “key repeat” may hold values of “perform” or “do not perform”. In a case where “key repeat” is set to “perform”, if, when a pressing of the touch panel 118 or a key button is accepted and the key button is long pressed, similar processing is performed to a case where the key button is pressed repetitively at constant intervals. Meanwhile, in a case where “key repeat” is set to “do not perform”, even if the key button is long pressed, similar processing is performed in a case where the key button is pressed only one time.

Firstly, in step S501, the CPU 111 accepts a pressing of the key button by the user. In a case where the key button is a button that is a target of switching of processing in accordance with the key repeat setting value, the setting value relating to the key repeat is obtained in order to execute the processing from step S502. In step S502, the CPU 111 determines whether or not the user has an authority to use personal setting values preferentially. At this time, the CPU 111 performs a user authentication, and obtains authority information of the user. The obtained user authority information of the user includes information about whether or not the user has the authority to use the personal setting values preferentially. In addition, information as to whether or not sharing setting values are used preferentially is included. The CPU 111 determines an existence or absence of the authority of the user by referencing the authority information of the user. In a case where the CPU 111, in step S502, determines that the user has the authority to use the personal setting values preferentially, the processing advances to step S503, and in a case where the CPU 111 determines that the user does not have the authority to use the personal setting values preferentially, the processing advances to step S504.

In step S503, the CPU 111 obtains the key repeat setting value associated with the personal setting value for the user, and advances the processing to step S505. Meanwhile, in step S504, the CPU 111 obtains the key repeat setting value associated with the sharing setting value and advances the processing to step S505. In step S505, the CPU 111, in accordance with the setting value obtained in step S503 or in step S504, executes the processing corresponding to the pressed key button. For example, in a case where “key repeat” is set to “perform”, key repeat processing is performed as long as the key button is pressed, and in a case where “do not perform” is set, the key repeat processing is not performed.

By virtue of this processing, in accordance with the authority that the user has, it is possible to switch automatically whether processing is executed prioritizing a personal setting value of the user or whether processing is executed prioritizing sharing setting value.

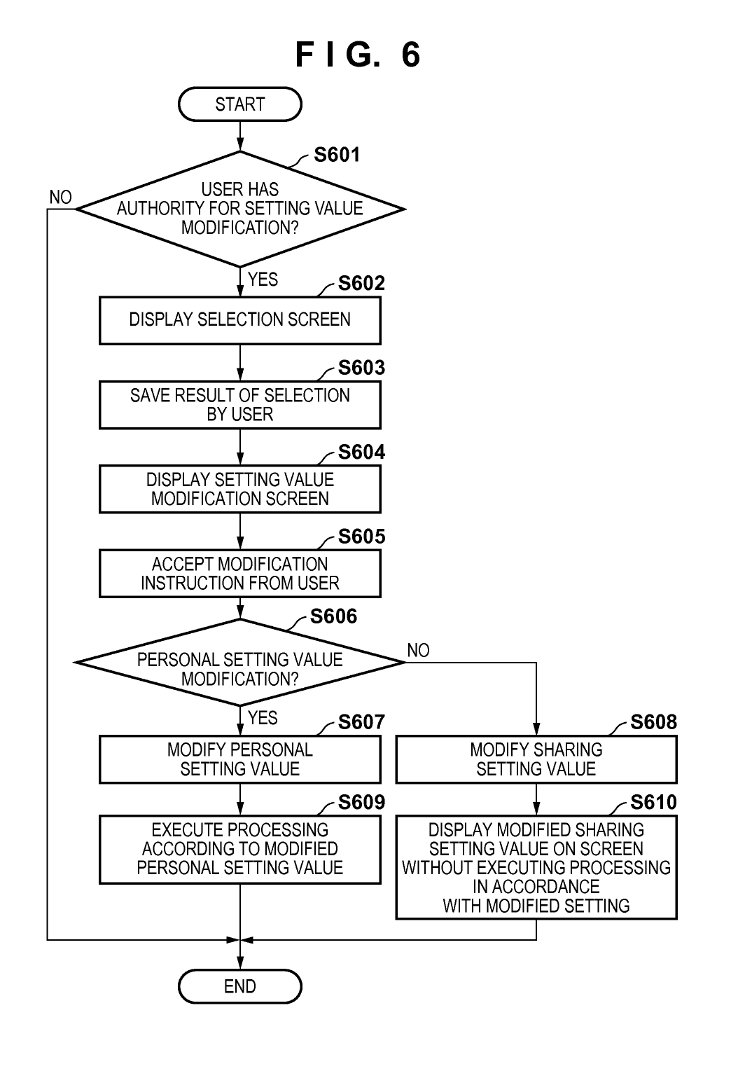

Next, in the first embodiment, detailed explanation will be given, using the flowchart of FIG. 6, for processing executed in accordance with a setting value when the setting value is modified.

FIG. 6 is a flowchart for describing an example of execution of processing in accordance with a personal setting value of the MFP 101 according to the first embodiment, in a case where a user modifies the personal setting value. Note that this processing is realized by the CPU 111 of the MFP 101 deploying into the RAM 112, and executing, a program stored in the ROM 113 or the external memory 120. Note that in FIG. 6 the processing of step S601 to step S608 is the same in content as that of step S401 to step S408 of FIG. 4, and so detailed explanation is omitted.

In step S609, the CPU 111 executes processing in accordance with the modified personal setting item. For example, in a case where the setting item is for the display language, and the setting “Japanese” is modified to “English”, the personal setting value is rewritten from “Japanese” to “English”. Then, the CPU 111, having received the rewriting of the personal setting value for the display language, executes processing for modifying the screen displayed on the display unit 119 from Japanese to English.

Meanwhile, in step S610, the CPU 111, having received the rewriting of a sharing setting value, displays the modified sharing setting value on one of the setting value display areas 303 and 304 of the setting value modification screen 300 without executing related processing, and the processing ends. For example, in a case where the setting item is “display language” and the setting item is modified from Japanese to English, the sharing setting value is rewritten from “Japanese” to “English”. However, the CPU 111, having received the setting value rewrite, leaves the screen displayed on the display unit 119 with the display of Japanese. Then, “English” is displayed on the setting value display area 304 of the setting value modification screen 300.

By the first embodiment, as explained above, it is possible to modify any setting value for a personal setting value or sharing setting value if the user having an authority modifies the setting values. If the modification is of a personal setting value, the modified setting value is reflected in the processing that the user is currently performing, and if the modification is of a sharing setting value, the modification of the sharing setting value is only displayed and thus can be confirmed.

With this, there is the effect that a user can confirm modified content of sharing setting value when an item of the sharing settings is modified in a case where a user is in a state in which personal setting values are used preferentially.

### Second Embodiment

In the previously described first embodiment, different processing is performed for a modification of a personal setting value than is performed for a modification of a sharing setting value. In contrast to this, in the second embodiment there is a feature that the same processing is performed for a modification of a personal setting value as is performed for a modification of a sharing setting value. Note that because the MFP 101, which functions as the image processing apparatus according to this embodiment, has a similar configuration to that of the MFP 101 of the previously described first embodiment, and so detailed explanation is omitted.

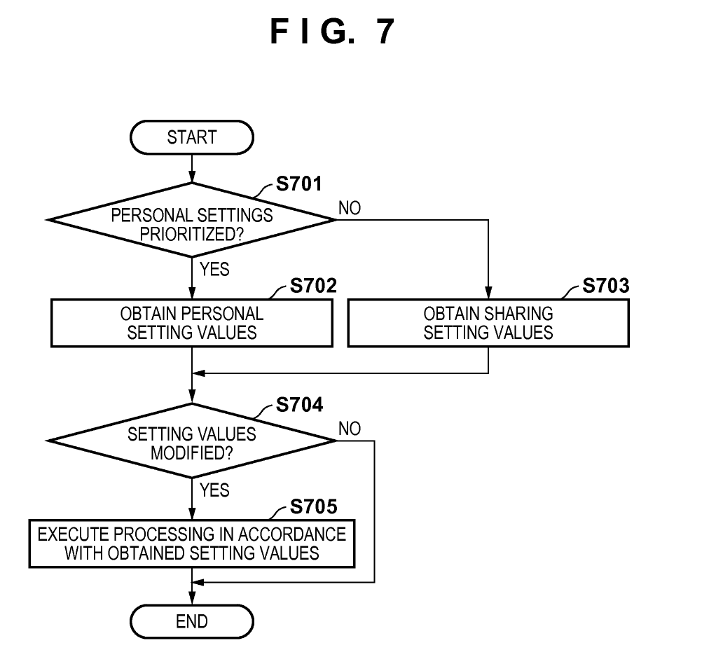

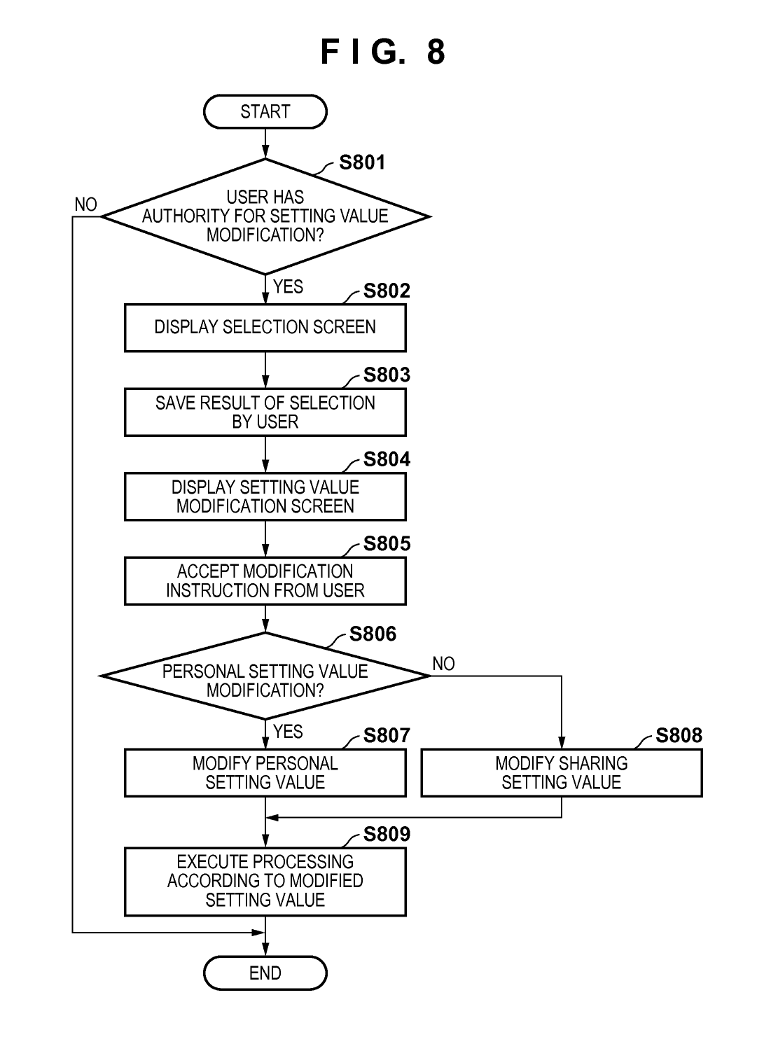

FIG. 7 is a flowchart for describing processing for accepting a modification of a setting value by a user in the MFP 101 according to a second embodiment. Note that this processing is realized by the CPU 111 of the MFP 101 deploying into the RAM 112, and executing, a program stored in the ROM 113 or the external memory 120.

A timing at which setting values are obtained is, for example, upon activation of the MFP 101, or upon a login of a user. When a user is authenticated by user login processing, there are cases in which the authority of the user is modified, and so whether or not the user has an authority to prioritize personal settings is also modified. In such a case it is necessary to perform the flowchart shown in FIG. 7 for the setting values once again, and to update the setting values.

Firstly, in step S701, the CPU 111 determines whether or not the user has the authority to prioritize personal settings. Here, the CPU 111 performs authentication of the user, and determines the authority of the user by using obtained authority information of the user. Here, in a case where the CPU 111 determines that the user has the authority to prioritize personal settings, the CPU 111 advances the processing to step S702. On the other hand, in a case where the CPU 111, in step S701, determines that the user does not have the authority to prioritize personal settings, the CPU 111 advances the processing to step S703.

In step S702, the CPU 111 obtains personal setting values for the user, and advances the processing to step S704. Meanwhile, in step S703, the CPU 111 obtains sharing setting values and advances the processing to step S704. In step S704, the CPU 111 determines whether or not the setting values obtained in step S702 or in step S703 match the setting values of the same setting items stored in the RAM 112 before the processing of FIG. 7 is started. In a case where the CPU 111, in step S704, determines that the setting values do not match, the CPU 111 advances the processing to step S705, and the CPU 111 executes processing in accordance with the obtained setting values. Here, for example, in a case where a setting item is for the display language, the setting value of the display language is obtained when the user performs login processing. Then, in a case where the obtained setting value is different from the display language currently used on the screen displayed on the display unit 119, the CPU 111 switches, in accordance with the obtained setting value, the display of the screen displayed on the display unit 119.

By virtue of this processing, when a personal setting value of a user or a sharing setting value is modified, the modified setting value is reflected upon processing of the user.

Next, explanation will be given for an example, in the second embodiment, in which when a personal setting value or a sharing setting value is modified, processing associated with the modified setting value is executed.

FIG. 8 is a flowchart for describing an example for executing processing in accordance with a personal setting value or a sharing setting, in a case where a user modifies the personal setting value or a sharing setting of the MFP 101 according to the second embodiment. Note that this processing is realized by the CPU 111 of the MFP 101 deploying into the RAM 112, and executing, a program stored in the ROM 113 or the external memory 120. Note that in FIG. 8 the processing of step S801 to step S808 is the same in content as that of step S401 to step S408 of FIG. 4, and so detailed explanation is omitted.

In step S809, the CPU 111 receives a rewrite of either a personal setting value or a sharing setting value, and executes processing in accordance with the content of the modified setting value. The CPU 111, in a case where the user has the authority to prioritize personal settings, executes processing in accordance with the modified sharing setting value if the sharing setting value is modified. For example, assume that for the setting item of the display language, in a state in which the personal setting value is set to Japanese and the sharing setting is set to English, the sharing setting value of the display language is modified from English to German. In such a case, the CPU 111 receives the modification of the sharing setting value, and switches the display of the screen displayed on the display unit 119 from Japanese or English to German.

By the second embodiment, as explained above, in a case where the user has the authority to prioritize personal settings, the personal setting values of the user are reflected in the display preferentially when setting values are obtained. Meanwhile, in a case where a personal setting value or a sharing setting value is modified, regardless of which kind of setting values is modified, the modified setting value is reflected in the processing. With this, even in a case where the sharing setting value is modified, the user is able to confirm the modified sharing setting value easily. Simultaneously giving preference to the personal settings can be realized.

### Third Embodiment

In the above described first and second embodiments, a feature is that the obtained setting value and the processing are switched in accordance with the authority of the user. In the third embodiment, a feature is that the obtained setting value and the processing are switched based on a setting value for which a destination is used to obtain setting values. Note that because the MFP 101, which functions as the image processing apparatus according to embodiments, has a similar configuration to that of the MFP 101 of the previously described first embodiment, detailed explanation is omitted.

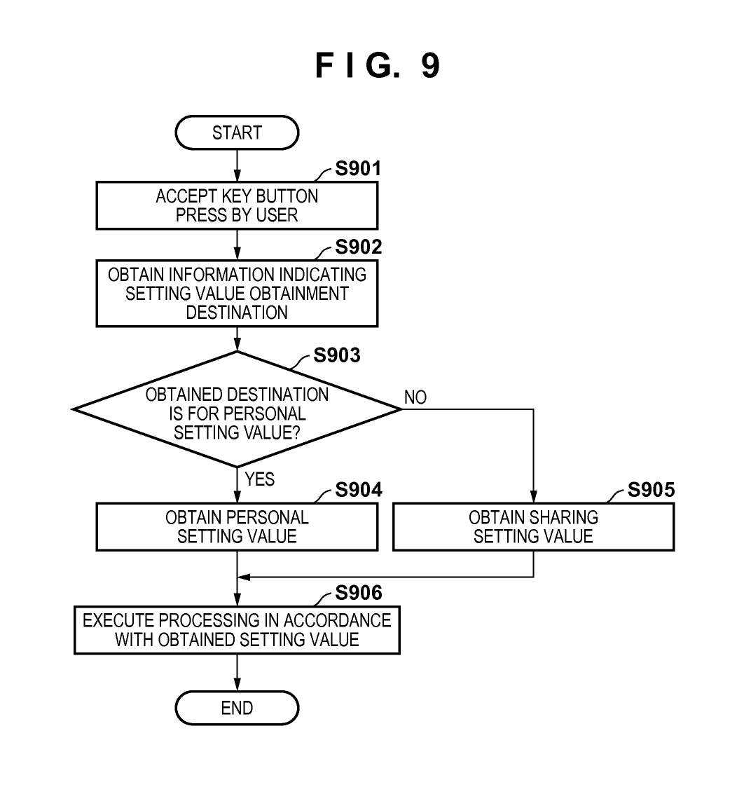

FIG. 9 is a flowchart for showing processing for obtaining a setting value based on information of a setting value obtainment destination in the MFP 101 according to a third embodiment. Note that this processing is realized by the CPU 111 of the MFP 101 deploying into the RAM 112, and executing, a program stored in the ROM 113 or the external memory 120.

Firstly, in step S901, the CPU 111 accepts a pressing of a key button by the user. In a case where the key button is a button for switching of processing in accordance with, for example, the key repeat setting value, the setting value relating to the key repeat is obtained in order to execute the processing from step S902.

In step S902, the CPU 111 reads out setting value obtainment destination information from a memory. The setting value obtainment destination information is a setting item by which it is set whether to obtain personal setting values or whether to obtain sharing setting values. The setting value obtainment destination information is information for determining a destination from which to obtain setting values, and usage of this information is not necessary when setting values are modified. Note that configuration may be taken in which the setting value obtainment destination information is modifiable only by a user that has an administrator authority.

In step S903, the CPU 111 determines whether or not the obtainment destination information obtained in step S902 is a setting for obtaining personal setting values. In step S903, in a case where the CPU 111 determines that personal setting values are obtained, the processing proceeds to step S904, and in a case where the CPU 111 determines that personal setting values are not obtained, and rather the setting value obtainment destination information is set to obtain sharing setting values, the CPU 111 advances the processing to step S905. Because the processing from step S904 to step S906 has the same content as FIG. 5 from step S503 to step S505, detailed explanation is omitted.

As explained above, by virtue of the third embodiment, even in a case where the user has the authority to prioritize personal settings, it is possible to switch so as to obtain sharing setting values. With this, even in a case where a sharing setting value is modified, the user is able to confirm the modified sharing setting value easily.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-244333, filed Nov. 26, 2013, which is hereby incorporated by reference herein in its entirety.

What is claimed is:

1. An image processing apparatus, comprising:
an operation unit configured to accept an operation of a user;
a storage unit configured to store a personal setting value and a sharing setting value which are set for the image processing apparatus; and
a display control unit configured to control, when a user, having an authority for modifying both the personal setting value and the sharing setting value, modifies the personal setting value of the user or the sharing setting value stored in the storage unit via the operation unit, to display modified personal setting value or modified sharing setting value on a display unit.

2. The image processing apparatus according to claim 1, further comprising:
a control unit configured to control, when the user, having the authority for modifying both the personal setting value and the sharing setting value stored in the storage unit, modifies the personal setting value of the user, to execute processing in accordance with the modified personal setting value.

3. The image processing apparatus according to claim 1, further comprising:
a control unit configured to control, when the user, having the authority for modifying both the personal setting value and the sharing setting value stored in the storage unit, modifies the personal setting value of the user or the sharing setting value, to execute processing in accordance with the modified personal setting value.

4. An image processing apparatus, comprising:
an operation unit configured to accept an operation of a user;
a storage unit configured to store a personal setting value and a sharing setting value which are set for the image processing apparatus;
a determination unit configured to determine, when the operation of the user is accepted via the operation unit, whether or not the user has an authority for executing processing giving priority to the personal setting value of the user; and
a control unit configured to control:
(i) when the determination unit determines that the user has the authority, to execute processing using the personal setting value of the user, and,
(ii) when the determination unit determines that the user does not have the authority, to execute processing using the sharing setting value stored in the storage unit.

5. The image processing apparatus according to claim 4, wherein even in a case where the user has the authority, in a case where the personal setting value of the user or the sharing setting value is modified, the control unit controls to execute the processing in accordance with the modified personal setting value or the modified sharing setting value.

6. An image processing apparatus, comprising:
an operation unit configured to accept an operation of a user;
a storage unit configured to store a personal setting value and a sharing setting value which are set for the image processing apparatus;
a determination unit configured to determine, when the operation of the user is accepted via the operation unit, whether or not a setting value to be used is the personal setting value or the sharing setting value; and
a control unit configured to control to execute processing using the personal setting value or the sharing setting value determined by the determination unit to be used.

7. The image processing apparatus according to claim 6, wherein the personal setting value and the sharing setting value include at least one of a setting for whether a key repeat is executed and a setting for a display language.

8. A method of controlling an image processing apparatus, the method comprising:
accepting an operation of a user;
storing, in a memory, a personal setting value and a sharing setting value which are set for the image processing apparatus; and
controlling, when a user, having an authority for modifying both the personal setting value and the sharing setting value, modifies, in the accepting, the personal setting value of the user or the sharing setting value stored in the memory, to display modified personal setting value or modified sharing setting value on a display unit.

9. A method of controlling an image processing apparatus, the method comprising:
accepting an operation of a user;
storing, in a memory, a personal setting value and a sharing setting value which are set for the image processing apparatus;
determining, when the operation of the user is accepted via the accepting, whether or not the user has an authority for executing processing giving priority to the personal setting value of the user; and
controlling:
(i) when determine that the user has the authority in the determination step, to execute processing using the personal setting value of the user, and,
(ii) when determine that the user does not have the authority in the determining, to execute processing using the sharing setting value stored in the storing.

10. A method of controlling an image processing apparatus, the method comprising:
accepting an operation of a user;
storing, in a memory, a personal setting value and a sharing setting value which are set for the image processing apparatus;
determining, when the operation of the user is accepted via the operation step, whether or not a setting value to be used is the personal setting value or the sharing setting value; and
controlling, to execute processing using the personal setting value or the sharing setting value determined in the determining to be used.

11. A non-transitory computer readable storage medium storing a program for causing a computer to execute a method of controlling an image processing apparatus, the method comprising:
accepting an operation of a user;
storing, in a memory, a personal setting value and a sharing setting value which are set for the image processing apparatus; and
controlling, when a user, having an authority for modifying both the personal setting value and the sharing setting value, modifies, in the accepting, the personal setting value of the user or the sharing setting value stored in the memory, to display modified personal setting value or modified sharing setting value on a display unit.
